(19) United States
(12) Patent Application Publication
(10) Pub. No.: US 2024/0368385 A1
(43) Pub. Date: Nov. 7, 2024

(54) SILANE MODIFIED FATTY ACID DERIVATIVES FOR RUBBER ADDITIVES

(71) Applicant: The Goodyear Tire & Rubber Company, Akron, OH (US)

(72) Inventors: Kelsey Elizabeth Cantwell, Akron, OH (US); Frank James Feher, Copley, OH (US); Thomas Franklin Spilker, Broadview Heights, OH (US); Joseph John Kulig, Tallmadge, OH (US)

(21) Appl. No.: 18/686,712

(22) PCT Filed: Aug. 25, 2022
(86) PCT No.: PCT/US2022/041522

§ 371 Date: Feb. 28, 2024

Related U.S. Application Data
(60) Provisional application No. 63/260,713, filed on Aug. 30, 2021.

(51) Int. Cl. C08L 9/06; B60C 1/00; C08K 3/06; C08K 3/36; C08L 1/02; C08L 3/04; C08L 5/08; C08L 7/00

(52) U.S. Cl. CPC C08L 9/06; B60C 1/0016; C08K 3/06; C08K 3/36; C08L 1/02; C08L 3/04; C08L 5/08; C08L 7/00; C08K 2201/019

(57) ABSTRACT

A rubber composition is disclosed comprising, based on 100 parts by weight of elastomer (phr): one or more elastomers selected from the group consisting of styrene-butadiene, polybutadiene, natural rubber, polyisoprene, and mixtures thereof; and a silylated material derived from a polyol or a polyol derivative. Also, a tire having a component comprising such a rubber composition is disclosed. Finally, a method of forming a sulfur-curable rubber composition for incorporation in a tire is disclosed, the method comprising: selecting a starting material comprising a polyol or a derivative of a polyol; condensing the starting material with a fatty acid to generate an esterified material; performing a silylation on the esterified material to generate a silylated material; and combining the silylated material with at least one elastomer in a rubber composition, the elastomer being selected from the group consisting of styrene-butadiene, polybutadiene, natural rubber, polyisoprene, and mixtures thereof.

### FIELD OF THE INVENTION

The present disclosure relates to a processing additive for use in rubber compounds and, more particularly, to a silylated fatty acid derivative. It finds particular application in conjunction with tires and treads and will be described with particular reference thereto. However, it is to be appreciated that the present exemplary embodiments are also amenable to other like applications.

### BACKGROUND OF THE INVENTION

Silica is widely used as a partial or full replacement of carbon black in tires to promote certain performance advantages, such as lowered rolling resistance, better wet traction and cold weather performance, and reduced noise, Unlike carbon black, which disperses easily within a hydrophobic elastomer, silica has a hydrophilic surface that makes it difficult to disperse in the elastomer. Various techniques were developed to incorporate silica fillers into the polymer compositions including, for example, treating an aqueous solution of silicic acid to precipitated silica directly onto carbon black; using cationic emulsifiers to distribute the filler within polymeric lattices; dry blending silica into polymers using a high-shear milling operation; treating silica with an organosilane coupling agent to improve dispersion during dry mixing; replacing the organosilane with phenoxy acidic acid and a methylene donor; and using mercaptosilanes as a coupling agent; among others. The tradeoffs between these and other approaches are summarized in US-A-2020/283,610.

US-A-2020/283,610 reports the utility of silylated triglyceride oil in rubber compounds and establishes the value that silane bearing oils can bring thereto. Further development is desired for providing other silylated materials that can bring separate, unique utilities to rubber compounds, which can then be employed in both the tire and other industries. Silica filled rubber formulations are desired from which improved processability (e.g., better extrusion quality) and performance are demonstrated. However, these objectives need to be attained without incurring penalties to other attributes. While tradeoffs are typically accepted between properties to realize a desired performance characteristic, a silica filled tread compound is targeted that displays an increase in low strain stiffness while it maintains a low hysteresis.

### SUMMARY OF THE INVENTION

The invention relates to a rubber composition in accordance with claim 1, a method of manufacturing in accordance with claim 13, and to a tire in accordance with claim 12.

Dependent claims refer to preferred embodiments of the invention.

In one aspect, the present disclosure is directed to silylated materials and, more particularly, to such materials derived from polyols. Such materials are contemplated for incorporation in rubber compositions to improve the characteristics of an article formed therefrom.

In one aspect, the disclosure is directed to a rubber composition for incorporation in a tire component. The rubber composition comprises:
(A) one or more elastomers selected from the group consisting of styrene-butadiene; polybutadiene; natural rubber; polyisoprene; and mixtures thereof;
(B) a silylated material, the silylated modified material being a polyol and/or a derivative therefrom functionalized with a silane; and optionally further a
(C) a filler or a rubber reinforcing filler.
   The disclosure is also directed to a tire component incorporating such a rubber composition, preferably as a sulfur-cured rubber composition. The tire component is preferably a tire tread or a tire tread cap.
   In another aspect, the disclosure is directed to a method of forming a sulfur-curable rubber composition for incorporation in a tire. The method comprises the steps of:
(A) selecting a starting material comprising a polyol or derivative of polyol;
(B) condensing the starting material with a fatty acid to generate an esterified material;
(C) performing silylation on the esterified material to generate a silylated modified material; and
(D) combining the silylated modified material with at least one elastomer in a rubber composition, the elastomer being selected from the group consisting of styrene-butadiene; polybutadiene; natural rubber; polyisoprene; and mixtures thereof.

### BRIEF DESCRIPTION OF THE DRAWINGS

The invention will be described by way of example and with reference to the accompanying drawings in which:

FIGS. 1A-1E show structures of example starting materials from which the disclosed silylated modified material is derived;

FIG. 2A shows the first reaction scheme in an example two-step chemical transformation in which glucose is the starting polyol;

FIG. 2B shows the second reaction scheme, continuing for the example shown in FIG. 2A;

FIG. 3A shows the first reaction scheme in an example two-step chemical transformation in which chitosan is the starting polyol; and

FIG. 3B shows the second reaction scheme, continuing for the example shown in FIG. 3A.

### DETAILED DESCRIPTION OF PREFERRED EMBODIMENT OF THE INVENTION

As used herein, except where context requires otherwise, the term “comprise” and variations of the term, such as “comprising”, “comprises” and “comprised”, are not intended to exclude further additives, components, integers, or steps.

As used herein, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art.

As used herein, the term “polyol” refers to any chemical or organic scaffold that bears two or more (≥) alcohols. This includes alcohol-bearing polymers, such as polyvinylalcohol and other examples.

One embodiment of the present disclosure is directed to a rubber composition comprising, based on 100 parts by weight of elastomer (phr):
(A) elastomers selected from the group consisting of styrene-butadiene; polybutadiene; natural rubber; polyisoprene; and mixtures thereof;
(B) a silylated material, the silylated material being a silylated product derived from a polyol; and
(C) an optional reinforcement filler.

### Rubber Elastomers

The disclosed rubber composition comprises at least one diene-based elastomer. In practice, various conjugated diene-based elastomers may be used for the rubber composition such as, for example, polymers and copolymers of at least one of isoprene and 1,3-butadiene and of styrene copolymerized with at least one of isoprene and 1,3-butadiene, and mixtures thereof.

Representative of such conjugated diene-based elastomers are, for example, at least one of cis 1,4-polyisoprene (natural and synthetic), cis 1,4-polybutadiene, styrene/butadiene copolymers (aqueous emulsion polymerization prepared and organic solvent solution polymerization prepared), medium vinyl polybutadiene having a vinyl 1,2-content in a range of 15 to 90 percent, isoprene/butadiene copolymers, styrene/isoprene/butadiene terpolymers. The cis-content in said cis 1,4-polyisoprene and/or said cis 1,4-polybutadiene is preferably at least 90%, more preferably at least 92%, at least 95 percent or at least 98 percent.

Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile, which polymerize with butadiene to form NBR, methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether.

Specific examples of synthetic rubbers include neoprene (polychloroprene), polybutadiene (including cis-1,4-polybutadiene), polyisoprene (including cis-1,4polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethyl-ene/propylene/diene monomer (EPDM), and in particular, ethylene/propyl-ene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. In practice, the preferred rubber or elastomers are polyisoprene (natural or synthetic), polybutadiene and SBR.

In a preferred embodiment, at least one elastomer is functionalized to react with a silica filler.

Representative of functionalized elastomers are, for example, styrene/butadiene elastomers containing one or more functional groups comprising:
(A) an amine functional group reactive with hydroxyl groups on silica or precipitated silica,
(B) a siloxy functional group, including end chain siloxy groups, reactive with hydroxyl groups on silica or precipitated silica,
(C) a combination of amine and siloxy functional groups reactive with hydroxyl groups on silica or precipitated silica,
(D) a combination of thiol and siloxy (e.g., ethoxysilane) functional groups reactive with hydroxyl groups on silica or precipitated silica,
(E) a combination of imine and siloxy functional groups reactive with hydroxyl groups on silica or precipitated silica,
(F) hydroxyl functional groups reactive with silica or precipitated silica.

For the functionalized elastomers, representatives of amine functionalized SBR elastomers are, for example, in-chain functionalized SBR elastomers as described in U.S. Pat. No. 6,936,669.

Representative of a combination of amino-siloxy functionalized SBR elastomers with one or more amino-siloxy groups connected to the elastomer is, for example, HPR355™ from JSR and amino-siloxy functionalized SBR elastomers as described in U.S. Pat. No. 7,981,966.

Representative styrene/butadiene elastomers end functionalized with a silane-sulfide group are, for example, as described in U.S. Pat. Nos. 8,217,103 and 8,569,409.

Organic solvent polymerization prepared tin coupled elastomers may also be used, such as, for example, tin coupled organic solution polymerization prepared styrene/butadiene co-polymers, isoprene/butadiene copolymers, styrene/isoprene copolymers, polybutadiene and styrene/isoprene/butadiene terpolymers including the aforesaid functionalized styrene/butadiene elastomers.

Tin coupled copolymers of styrene/butadiene may be prepared, for example, by introducing a tin coupling agent during the styrene/1,3-butadiene monomer copolymerization reaction in an organic solvent solution, usually at or near the end of the polymerization reaction.

In practice, it is usually preferred that at least 50 percent and more generally in a range of 60 to 85 percent of the Sn (tin) bonds in the tin coupled elastomers are bonded to butadiene units of the styrene/butadiene copolymer to create Sn-dienyl bonds such as butadienyl bonds.

Creation of tin-dienyl bonds can be accomplished in a number of ways such as, for example, sequential addition of butadiene to the copolymerization system or use of modifiers to alter the styrene and/or butadiene reactivity ratios for the copolymerization.

Various tin compounds, particularly organo tin compounds, may be used for the coupling of the elastomer. Representative of such compounds are, for example, alkyl tin trichloride, dialkyl tin dichloride, yielding variants of a tin coupled styrene/butadiene copolymer elastomer, although a trialkyl tin monochloride might be used which would yield simply a tin-terminated copolymer.

Examples of tin-modified, or coupled, styrene/butadiene copolymer elastomers can be found, for example in U.S. Pat. No. 5,064,901.

Emulsion polymerization prepared styrene/butadiene/acrylonitrile copolymer rubbers containing 2 to 40 weight percent bound acrylonitrile in the copolymer are also contemplated as diene-based rubbers for use in this invention.

By emulsion polymerization prepared E-SBR, it is meant that styrene and 1,3-butadiene are copolymerized as an aqueous emulsion. The bound styrene content can vary, for example, from 5 to 50 percent. In one aspect, the E-SBR may also contain acrylonitrile to form a terpolymer rubber, as E-SBAR, in amounts, for example, of 2 to 30 weight percent bound acrylonitrile in the terpolymer.

It is further contemplated that, in certain embodiments, the rubber elastomer may be a butyl type rubber, particularly copolymers of isobutylene with a minor content of diene hydrocarbon(s), such as, for example, isoprene and halogenated butyl rubber.

In one embodiment, the rubber composition comprises from 0 to 100 phr or from 10 to 90 phr of a first rubber elastomer in a composition comprising at least two different elastomers. In one embodiment, an additional diene-based elastomer is employed such that the composition comprises the combination of at least two different elastomers (synthetic and/or natural). For example, the additional conjugated diene-based elastomer may also be present in the rubber composition in the amount of from 1 to 100 phr and, more specifically, from 10 to 90 phr. In one embodiment, at least a third different rubber elastomer is employed. The first and second, and optional additional elastomers, are provided in amounts that total 100 phr.

### Processing Additive—Silylated Modified Material

An important aspect of the present disclosure is the incorporation of a silylated modified material into a rubber composition. In one embodiment, the silylated material is derived from a polyol, which in some embodiments may optionally exclude glycerol.

In the contemplated embodiment, the silylated modified material is derived from polyol and, as such, is referred synonymously herein as a “silylated polyol”.

A wide variety of starting polyols can be used in the practice of this invention with esters (non-triglyceride cores derived from polyols), carbohydrates (sugars, polysaccharides), pentaerythritol, and polyvinyalcohol-based polyols being typically employed.

Examples of the starting polyols can include simple saccharides, oligosaccharides, and polysaccharides. The polysaccharides can include cellulose, starch, lignin, chitosan, chitin, pectin, glycogen, and arabinoxylan. In a preferred embodiment, a polyol-containing core is the reagent employed for esterification. One example of a polyol-containing core is pentaerythritol. In yet further embodiments, oligomers or polymers bearing two or more alcohol functionalities can be used as the starting material.

When a monosaccharide, represented by the formula (CH₂O)ₙ, is selected as the starting material, the invention contemplates that n is greater than or equal to (≥) 2. A starting oligosaccharide or polysaccharide for use in the present invention would have the formula Cₓ(H₂O)_{y}, wherein x and y are independent of each other and each can be greater than or equal to 190. In one embodiment, x can be from 200 to 2500.

Examples of starting amines that may be used in the present invention can be chitosan, valine, or valine-containing peptides. In other embodiments, amine-bearing oligomers or polymers may be used for condensation, such as polyethylenimine, which may be branched or dendritic to generate the primary amines. In a further embodiment, the starting amide for transamidation may include chitan.

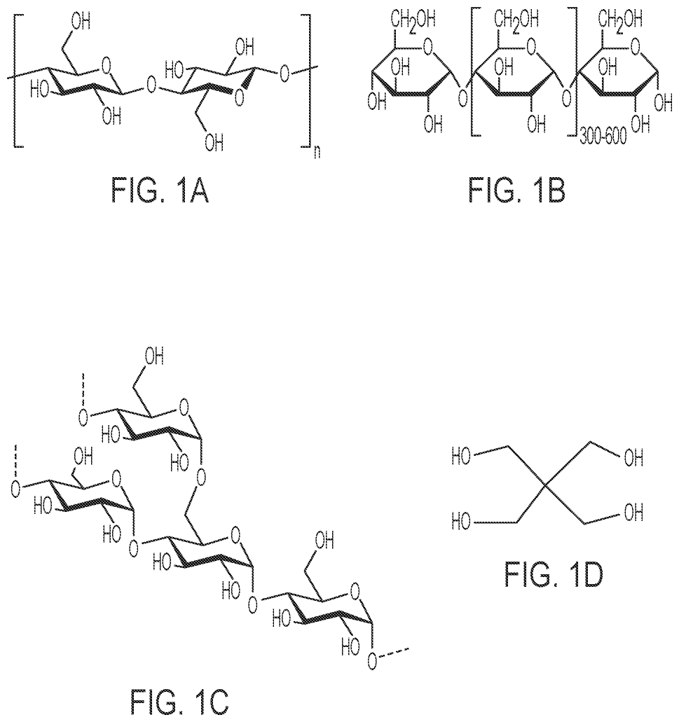

FIGS. 1A-1E show examples of starting materials from which the disclosed silylated material can be derived. FIG. TA shows the general structure of cellulose; FIG. 1B shows the general structure of chitosan; FIG. 1C shows the general structure of chitin; FIG. 1D shows the general structure of pentaerythritol, and FIG. 1E shows the structure of allosucrose.

In a preferred embodiment, the starting material is a naturally-occurring, sustainable polyol such that it is completely devoid of petroleum and/or petrochemicals.

In one embodiment, the silylated modified material may be produced by a two-step reaction in which (1) fatty acid(s) is condensed with alcohols or amines to generate an esterified or amide product, respectively, of the first action and (2) the esterified or amide product—i.e., the reagent in the second reaction—then undergoes silylation to generate the final silylated material.

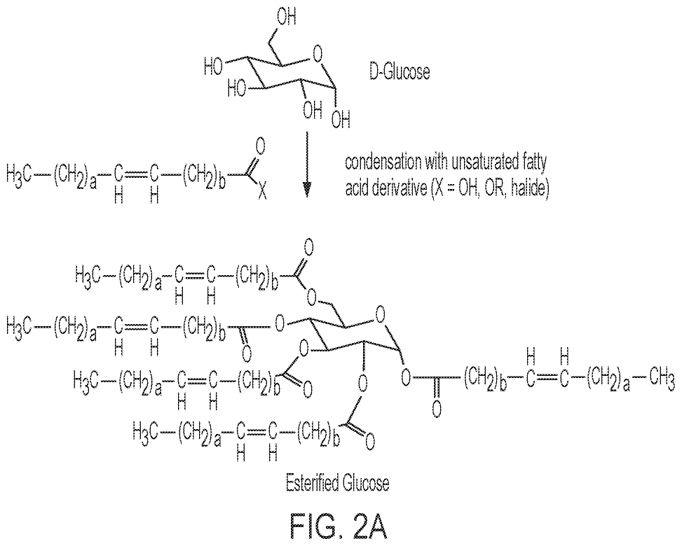

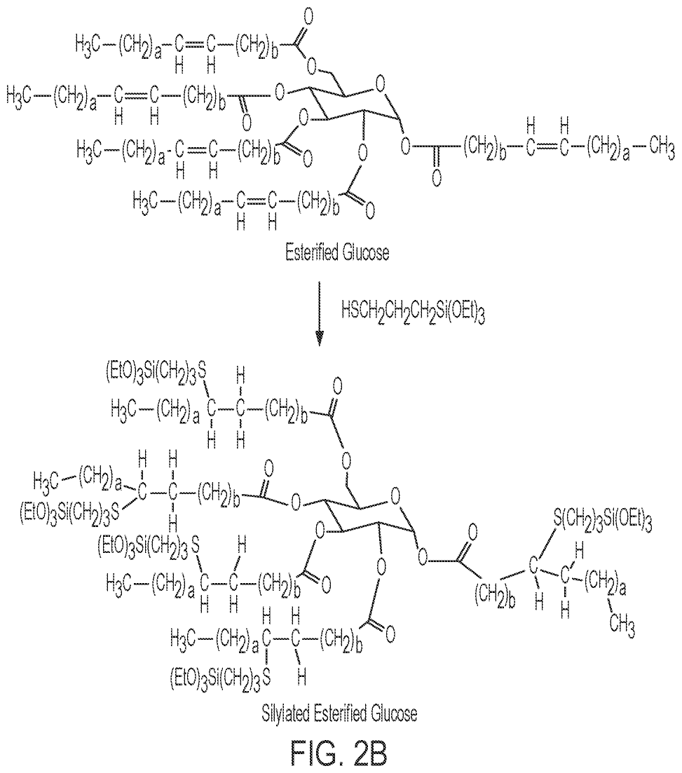

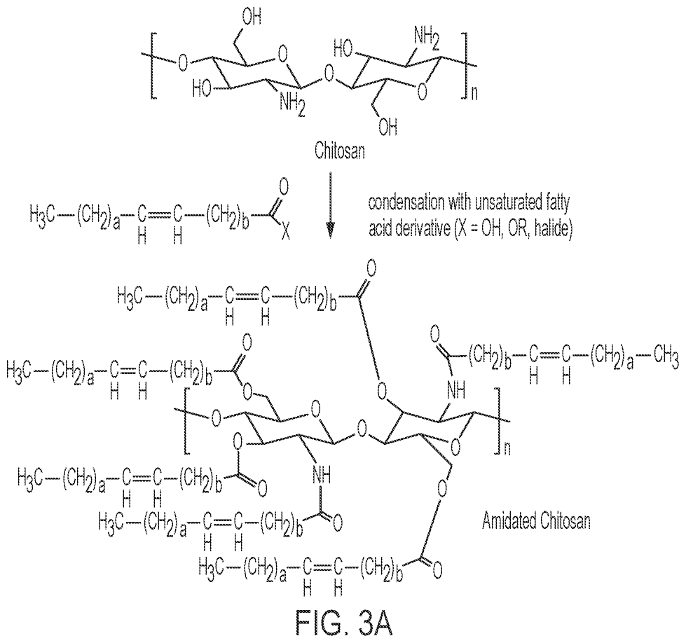

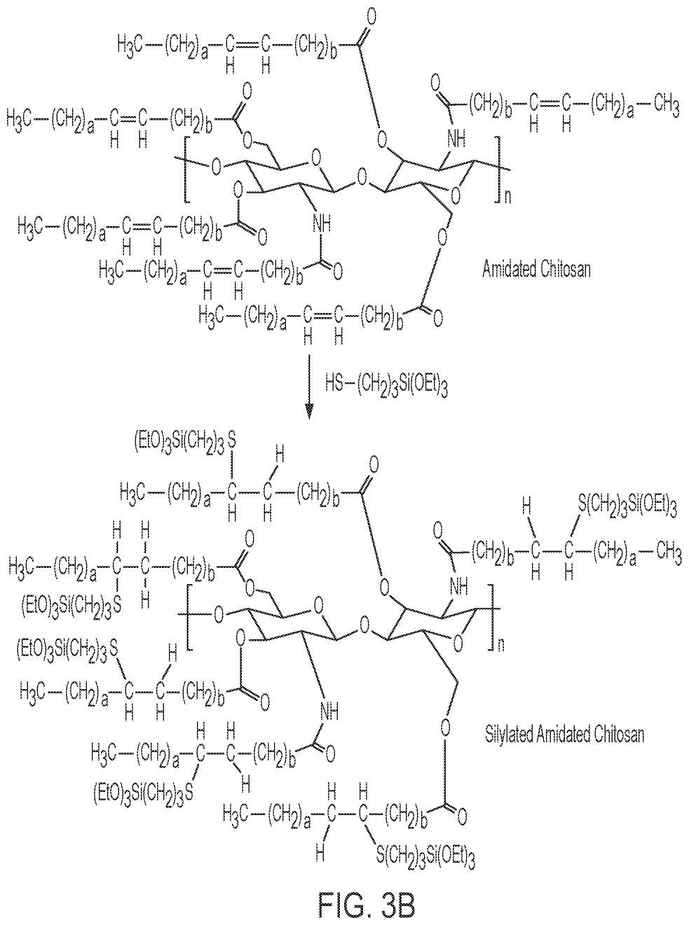

Turning to FIGS. 2 and 3, example reaction schemes for the two-step chemical transformation are shown for illustrative purposes only. FIGS. 2A and 2B show the reaction schemes in an example two-step chemical transformation in which glucose is the starting polyol. In the first reaction scheme, shown in FIG. 2A, fatty acid is condensed with the glucose to produce an esterified product. Once the esterified product has been obtained, the olefins on any unsaturated fatty acid chains may be silylated, shown in FIG. 2B to generate the silylated modified material. FIGS. 3A and BB show the reaction schemes in an example two-step chemical transformation in which chitosan is the starting polyol. In the first reaction scheme, shown in FIG. 3A, fatty acid is condensed with the chitosan to produce an amidated product. Once the amidated product has been obtained, the olefins on any unsaturated fatty acid chains may be silylated to generate the silylated material.

FIGS. 2B and 3B show the silylated products produced using a thiol-ene reaction with mercaptopropyltriethoxysilane. However, there is no limitation made herein to the reagent or the reaction used for performing the silylation. Any silylation process known to those skilled in the art may be used. Furthermore, while a complete silylation is shown in the illustrative reaction schemes of FIGS. 2 and 3, partial silylation is also contemplated within the scope of the present disclosure.

The final silylated material preferably includes silyl groups of the structural formula —(CH₂)n-Si(OR)₃, wherein n represents an integer within the range of from 1 to 8, and wherein R represents an alkyl group containing from 1 to 8 carbon atoms.

The silylated material preferably includes silyl groups of the structural formula —S—(CH₂)n-Si(OR)₃, wherein n represents an integer within the range of from 1 to 8, and wherein R represents an alkyl group containing from 1 to 8 carbon atoms. For instance, the silylated modified material can include silyl groups of the structural formula: —S—(CH₂)₃—Si(O—CH₂CH₃)₃.

Each silylated material is contemplated to contribute a unique set of properties, depending on the structural/functional relationship the given application or rheological target, and is selected to suit a desired application or target characteristic. Depending on the selected starting polyol, a wide range of useful materials can be synthesized. For example, in one embodiment, silylation of starch or lignin will yield a novel filler for a rubber composition. In other words, such silylated modified material can be used for partially or fully replacing conventional filler in the rubber composition. In a different embodiment, silylation of a select monosaccharide or oligomeric amine can yield a novel resin that can partially or fully replace conventional resins. It is further expected that incorporation of the silylated modified materials in silica reinforced rubber formulations can reduce and/or eliminate the silica coupling agent(s) needed in that formulation. Although, depending on a starting material selected to undergo silylation and/or modification, the resulting silylated modified material can be employed as a partial or full replacement of at least one of oil, resin, filler, and/or silica coupler in the rubber composition.

In one embodiment, the disclosed rubber composition comprises as the silylated modified material, from 0.5 to 30 phr, and more preferably from 5 to 20 phr or from 2 to 8 phr or from 5 to 15 phr, of at least one silylated esterified product or silylated amidated product.

### Oil

The rubber composition may optionally include rubber processing oil or may be free of such rubber processing oil. The rubber composition can include from 0 to 60 phr or from 2 to 45 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. In one embodiment, the rubber composition includes a low PCA oil. Suitable low PCA oils include but are not limited to mild extraction solvates (MES), treated distillate aromatic extracts (TDAE), residual aromatic extract (RAE), SRAE, and heavy naphthenic oils as are known in the art; see, for example, U.S. Pat. Nos. 5,504,135; 6,103,808; 6,399,697; 6,410,816; 6,248,929; 6,146,520; U.S. Published Applications 2001/00023307; 2002/0000280; 2002/0045697; 2001/0007049; EP-A-0 839 891; JP-A-2002-097369; and ES 2122917.

Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

Suitable TDAE oils are available as Tudalen® SX500 from Klaus Dahleke KG, VivaTec® 400 and VivaTec® 500 from H&R Group, and Enerthene® 1849 from BP, and Extensoil® 1996 from Repsol. The oils may be available as the oil alone or along with an elastomer in the form of an extended elastomer.

Suitable vegetable oils include, for example, soybean oil, sunflower oil, rapeseed oil, and canola oil which are in the form of esters containing a certain degree of unsaturation.

### Filler

The vulcanizable rubber composition may include from 0 to 200 phr, from 5 to 150 phr, or from 30 to 150 phr, of a filler or a rubber reinforcing filler, such as silica, carbon black, or a combination of both.

The silica filler may be any suitable silica or a combination of any such silica. Commonly used siliceous pigments that are used in rubber compounding applications include pyrogenic and precipitated siliceous pigments (silica), as well as precipitated high surface area (“HSA”) silica and highly dispersive silica (“HDS”).

The conventional siliceous pigments preferably employed in this invention are precipitated silicas such as, for example, those obtained by the acidification of a soluble silicate, e.g., sodium silicate.

The precipitated silicas can be characterized, for example, by having a BET surface area, as measured using nitrogen gas, preferably in the range of 40 to 600, and more usually in a range of 50 to 300 square meters per gram. The BET method of measuring surface area is described in the Journal of the American Chemical Society, Volume 60, page 304 (1930). The conventional silica may also be typically characterized by having a dibutylphthalate (DBP) absorption value in a range of 100 to 400, and more usually 150 to 300. The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as silicas commercially available from PPG Industries under the Hi-Sil trademark with designations 210, 243 and 315; silicas available from Rhodia, with, for example, designations of Z1165MP, Z165GR and Zeosil Premium® 200MP; and silicas available from Degussa AG with, for example, designations VN2 and VN3.

When precipitated silica is a pre-hydrophobized precipitated silica, additional precipitated silica (non-pre-hydrophobized silica) and/or a coupling agent may optionally be added to the rubber composition.

### Coupling Agent

In preferred embodiments, the rubber composition includes from 0 to 20 phr or from 1 phr to 20 phr, of a silane coupling agent. In one embodiment, the rubber composition may comprise a silane coupling agent in response to the reinforcement filler being silica.

The silane coupling agent may be any suitable silane coupling agent, such as bis(ω-trialkoxyalkylsilyl) polysulfide, ω-mercaptoalkyl-trialkoxysilane, or combination thereof. In one example, the bis-(ω-trialkoxysilylalkyl) polysulfide has an average of from 2 to 4 connecting sulfur atoms in its polysulfidic bridge. In another example, the bis-(ω-trialkoxysilylalkyl) polysulfide has an average of from 2 to 2.6 connecting sulfur atoms in its polysulfidic bridge. In yet another example, the bis-(ω-trialkoxysilylalkyl)polysulfide has an average of from 3.3 to 3.8 connecting sulfur atoms in its polysulfidic bridge. The alkyl group of the silylalkyl moiety of the bis-(ω-trialkoxysilylalkyl)polysulfide may be a saturated C₂-C₆ alkyl group, e.g., a propyl group. In addition, at least one of the alkyl groups of the trialkoxy moiety of the bis-(ω-trialkoxysilylalkyl)polysulfide can be an ethyl group and the remaining alkyl groups of the trialkoxy moiety can be independently saturated C₂-C₁₈ alkyls. In another example, at least two of the alkyl groups of the trialkoxy moiety of the bis-(ω-trialkoxysilylalkyl) polysulfide are ethyl groups and the remaining alkyl group of the trialkoxy moiety is independently a saturated C₃-C₁₈ alkyl. In one example, the bis-(ω-trialkoxysilylalkyl) polysulfide coupling agent is bis-3-(triethoxysilylpropyl) tetrasulfide (“TESPD”). In another example, the bis-(ω-trialkoxysilylalkyl) Polysulfide coupling agent is bis-3-(triethoxysilylpropyl) tetrasulfide (“TESPT”). The omercaptoalkyltrialkoxysilane may have its mercapto moiety blocked from pre-reacting with hydroxyl groups (e.g., silanol groups) contained on the precipitated silica aggregates prior to unblocking the blocked mercapto moiety at an elevated temperature. In one example, the blocked ω-mercaptoalkyl-trialkoxysilane is NXT or NXT-LoV available from GE Silicones of Tarrytown, N.Y.

The silane coupling agent is preferably present in the rubber compound in an amount no greater than 15% by weight of silica. In another preferred example, the silane coupling agent is present in an amount less than 5% by weight of silica.

Carbon Black and/or Additional Filler

Additional filler material, e.g., carbon black, and others well known to those having ordinary skill in the art may also be included in the rubber compound in the desired phr. Representative examples of such carbon blacks include N110, N121, N134, N220, N231, N234, N242, N293, N299, 5315, N326, N330, M332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers that may be used in the rubber composition include particulate fillers such as ultra-high molecular weight polyethylene (UHMWPE), particulate polymer gels such as those disclosed in U.S. Pat. Nos. 6,242,534; 6,207,757; 6,133,364; 6,372,857; 5,395,891; or 6,127,488, and plasticized starch composite filler such as that disclosed in U.S. Pat. No. 5,672,639.

### Resin

Another component of the rubber composition is from 0 to 70 phr, preferably from 5 to 60 phr, of a resin. The rubber composition may also be resin free. In some embodiments, performance characteristics of rubber composition can be based on the type of resin employed in the rubber composition and, more particularly, the resin characteristics, such as, among others, the glass transition temperature (Tg). Therefore, in some embodiments, selection of the silylated modified material can be based on the resin selected for use in the rubber composition, or vice versa.

Measurement of Tg for resins is DSC according to ASTM D6604 or equivalent. Resin softening point is determined by ASTM E28, which might sometimes be referred to as a ring and ball softening point.

In one embodiment, the resin is selected from the group consisting of any hydrocarbon chemistry type resin (AMS, coumarone-indene, C5, C9, C5/C9, DCPD, DCPD/C9, others) & any modification thereof (phenol, C9, hydrogenation, recycled monomers, others) and any renewable biobased chemistry type resin (like any polyterpene, gum rosin, tall oil rosin, etc.) and modification (phenol, C9, hydrogenation, DCPD, esters, others) and mixture thereof.

In one embodiment, the resin is a coumarone-indene resin containing coumarone and indene as the monomer components making up the resin skeleton (main chain). Monomer ingredients other than coumarone and indene which may be incorporated into the skeleton are, for example, methyl coumarone, styrene, alphamethylstyrene, methylindene, vinyltoluene, dicyclopentadiene, cyclopentadiene, and diolefins such as isoprene and piperylene. Suitable coumarone-indene resin is available commercially as Novares® C30 from Ruetgers Novares GmbH.

Suitable petroleum resins include both aromatic and nonaromatic types. Several types of petroleum resins are available. Some resins have a low degree of unsaturation and high aromatic content, whereas some are highly unsaturated and yet some contain no aromatic structure at all. Differences in the resins are largely due to the olefins in the feedstock from which the resins are derived. Conventional derivatives in such resins include any C5 species (olefins and diolefins containing an average of five carbon atoms) such as cyclopentadiene, dicyclopentadiene, diolefins such as isoprene and piperylene, and any C9 species (olefins and diolefins containing an average of 9 carbon atoms) such as vinyltoluene, alphamethylstyrene and indene. Such resins are made by any mixture formed from C5 and C9 species mentioned above.

The styrene/alphamethylstyrene resin is considered herein to be a relatively short chain copolymer of styrene and alphamethylstyrene. The styrene/alphamethylstyrene resin may have, for example, a styrene content in a range of from 10 to 90 percent. In one aspect, such a resin can be suitably prepared, for example, by cationic copolymerization of styrene and alphamethylstyrene in a hydrocarbon solvent. Thus, the contemplated styrene/alphamethylstyrene resin can be characterized, for example, by its chemical structure, namely, its styrene and alphamethylstyrene contents and by its glass transition temperature, molecular weight and molecular weight distribution. Suitable styrene/alphamethylstyrene resin is available commercially as PURE 20 AS from Ruetgers Novares GmbH.

Terpene-phenol resins may be used. Terpene-phenol resins may be derived by copolymerization of phenolic monomers with terpenes such as limonenes, pinenes and delta-3-carene.

In one embodiment, the resin is a resin derived from rosin and derivatives. Representative thereof are, for example, gum rosin, wood rosin and tall oil rosin. Gum rosin, wood rosin and tall oil rosin have similar compositions, although the amount of components of the rosins may vary. Such resins may be dimerized, polymerized or disproportionated. Such resins may be in the form of esters of rosin acids and polyols such as pentaerythritol or glycol.

In one embodiment, such resin may be partially or fully hydrogenated.

### Sulfur Curative

It may be preferred to have the rubber composition for use in the tire component to additionally contain a conventional sulfur containing organosilicon compound. The rubber composition can comprise 0 to 40 ph of sulfur containing organosilicon compound. Examples of suitable sulfur containing organosilicon compounds are of the formula:

Z-Alk-Sₙ-Alk-Z I

in which Z is selected from the group consisting of

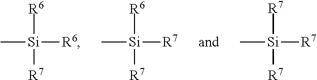

where R⁶ is an alkyl group of 1 to 4 carbon atoms, cyclohexyl or phenyl; R⁷ is alkoxy of 1 to 8 carbon atoms, or cycloalkoxy of 5 to 8 carbon atoms; Alk is a divalent hydrocarbon of 1 to 18 carbon atoms and n is an integer of 2 to 8.

The preferred sulfur containing organosilicon compounds are the 3,3′-bis(trimethoxy or triethoxy silylpropyl) sulfides.

The most preferred compounds are 3,3′-bis(triethoxysilylpropyl) disulfide and 3,3′-bis(triethoxysilylpropyl) tetrasulfide.

Therefore, as to formula I, preferably Z is

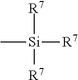

where R⁷ is an alkoxy of 2 to 4 carbon atoms, with 2 carbon atoms being particularly preferred; alk is a divalent hydrocarbon of 2 to 4 carbon atoms with 3 carbon atoms being particularly preferred; and n is an integer of from 2 to 5 with 2 and 4 being particularly preferred.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O) —S—CH₂CH₂CH₂Si(OCH₂CH₃)₃, which is available commercially as NXT™ from Momentive Performance Materials.

In another embodiment, suitable sulfur containing organosilicon compounds include compounds disclosed in U.S. Publication 2006/0041063. In one embodiment, the sulfur containing organosilicon compounds include the reaction product of hydrocarbon based diol (e.g., 2-methyl-1,3-propanediol) with S-[3-(triethoxysilyl)propyl]thiooctanoate. In one embodiment, the sulfur containing organosilicon compound is NXT-Z™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound of formula I in a rubber composition will vary depending on the level of other additives that are used. The amount of the compound of formula I will range from 0.5 to 20 phr. Preferably, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Preferably, the sulfur-vulcanizing agent is elemental sulfur. The sulfur-vulcanizing agent may be used in an amount ranging from 0.5 to 8 phr, with a range of from 1 to 6 phr being preferred. Typical amounts of antioxidants comprise 1 to 5 phr. Representative antioxidants may be, for example, diphenyl-p-phenylenediamine and others, such as, for example, those disclosed in The Vanderbilt Rubber Handbook (1978), pages 344 through 346. Typical amounts of antiozonants comprise 1 to 5 phr. Typical amounts of fatty acids, if used, which can include stearic acid comprise 0.5 to 5 phr. Typical amounts of waxes comprise 1 to 5 phr. Often microcrystalline waxes are used. Typical amounts of peptizers comprise 0.1 to 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from 0.5 to 6, preferably 0.8 to 4, phr. In another embodiment, combinations of a primary and a secondary accelerator might be used with the secondary accelerator being used in smaller amounts, such as from 0.05 to 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The disclosure contemplates a tire component formed from such method. Similarly, the tire component may be incorporated in a tire. The tire component can be ground contacting or non-ground contacting. The tire can be pneumatic or non-pneumatic. In one embodiment, the tire component is a tread.

The tire of the present invention may be a race tire, passenger tire, aircraft tire, agricultural, earthmover, off-the-road, or truck tire. Preferably, the tire is a passenger or truck tire. The tire may also be a radial or bias, with a radial being preferred.

While a tire and/or tire component are contemplated uses for the rubber composition disclosed herein, the disclosed silylated modified material can be used in compositions to form other articles including chewing gum, golf balls, hosing, belts, and shoes.

Vulcanization of a pneumatic tire of the present invention is generally carried out at conventional temperatures ranging from 100° C. to 200° C. Preferably, the vulcanization is conducted at temperatures ranging from 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

1. A rubber composition comprising, based on 100 parts by weight of elastomer (phr):
(A) one or more elastomers selected from the group consisting of styrene-butadiene, polybutadiene, natural rubber, polyisoprene, and mixtures thereof; and
(B) a silylated material derived from a polyol or a polyol derivative.

2. The rubber composition of claim 1 further comprising a rubber reinforcing filler.

3. The rubber composition of claim 1 or 2 wherein the polyol derivative is functionalized with a silane.

4. The rubber composition of any one of the previous claims wherein the silylated material is a product of a silylation of a material selected from a group consisting of a naturally occurring polyol, a pentaerythritol, a polyvinylalcohol-based polyol and an ester derived therefrom.

5. The rubber composition of any one of the previous claims wherein the silylated material is a product of at least one of a condensation and silylation reaction starting with the polyol, the polyol comprising at least one of a saccharide, an oligosaccharide, and a polysaccharide.

6. The rubber composition of claim 5, wherein the polysaccharide is at least one of a cellulose, a starch, a lignin, a chitosan, a chitin, a pectin, a glycogen, and an arabinoxylan.

7. The rubber composition of any one of the previous claims wherein the polyol is a monosaccharide of the general formula (CH₂O)ₙ, wherein n is equal to or greater than 3, or wherein the polyol is an oligosaccharide, preferably an oligosaccharide comprising from two to ten monosaccharides, or wherein the polyol is a polysaccharide of the general formula Cₓ(H₂O)_{y}, where x is greater than or equal to 200 and y is greater than or equal to 190.

8. The rubber composition of any one of the previous claims wherein the silylated material is one of a silylated esterified product of a polymer containing two or more alcohols or a silylated amidated product of an amine.

9. The rubber composition of any one of the previous claims wherein the rubber composition is free of a processing oil and/or wherein the rubber composition is free of a silica coupler.

10. The rubber composition of any one of the previous claims wherein the silylated material is a resin or is a filler, and/or wherein the silylated material is operative to react with silica.

11. The rubber composition of any one of the previous claims wherein the rubber composition is sulfur curable.

12. A tire having a component, preferably a tread or a ground-contacting tire component, comprising the rubber composition of any one of the previous claims as a sulfur cured rubber composition.

13. A method of forming a sulfur-curable rubber composition for incorporation in a tire, the method comprising:
(A) selecting a starting material comprising a polyol or a derivative of a polyol;
(B) condensing the starting material with a fatty acid to generate an esterified material;
(C) performing a silylation on the esterified material to generate a silylated material; and
(D) combining the silylated material with at least one elastomer in a rubber composition, the elastomer being selected from the group consisting of styrene-butadiene, polybutadiene, natural rubber, polyisoprene, and mixtures thereof.

14. The method of claim 13 wherein the silylated material partially or fully replaces at least one of oil, resin, filler, and silica coupler in the rubber composition.

15. The method of claim 13 or 14, wherein the silylated material is a product of a silylation of a material selected from the group consisting of:
a naturally occurring polyol;
a pentaerythritol;
a polyvinylalcohol-based polyol; and
an ester derived therefrom.

16. The method of any one of claims 13 to 15 wherein the silylated material is a product of at least one of a condensation and silylation reaction starting with the polyol, the polyol comprising at least one of a saccharide, an oligosaccharide, and a polysaccharide.

17. The method of claim 16 wherein (i) the polysaccharide is at least one of a cellulose, a starch, a lignin, a chitosan, a chitin, a pectin, a glycogen, and an arabinoxylan;
(ii) the polyol is a monosaccharide of the general formula (CH₂O)ₙ, wherein n is equal to or greater than 3,
(iii) the polyol is one of the oligosaccharide and the polysaccharide of the general formula Cₓ(H₂O)_{y}, where x and y are equal to or greater than 1.

18. The method of any one of claims 13 to 17 wherein the silylated material includes silyl groups of at least one of the following structures:
(A) —(CH₂)n-Si(OR)₃, wherein n represents an integer within the range of from 1 to 8, and wherein R represents an alkyl group containing from 1 to 8 carbon atoms; and
(B) —S—(CH₂)n-Si(OR)₃, wherein n represents an integer within the range of from 1 to 8, and wherein R represents an alkyl group containing from 1 to 8 carbon atoms.
